(19) United States
(12) Patent Application Publication
(10) Pub. No.: US 2013/0176342 A1
(43) Pub. Date: Jul. 11, 2013

(54) SYSTEM AND METHOD FOR IMAGING DNA SEQUENCES FOR GENE-TARGETING PROCESS

(71) Applicants: Liqun Zhu, Smithtown, NY (US); Wei Weng, Sayville, NY (US)

(72) Inventors: Liqun Zhu, Smithtown, NY (US); Wei Weng, Sayville, NY (US)

(21) Appl. No.: 13/347,737

(22) Filed: Jan. 11, 2012

(51) Int. Cl. G09G 5/00; G09G 5/373

(52) U.S. Cl. 345/660; 345/619

(57) ABSTRACT

A computer-implemented method for imaging DNA sequences for gene-targeting process; the method includes receiving a wild type sequence and targeting vector components comprising a modification. The method further includes generating a graphical display image where proportional icons represent the wild type sequence and the targeting vector and the modification may be visually aligned with the replacement region of the wild type sequence. In some embodiments a resulting knockout/knockin model may also be shown and sequence motifs may be accurately located on the graphical display image.

### TECHNICAL FIELD

The present invention relates to computer displays of graphical images associated with DNA sequences in gene-targeting processes.

### BACKGROUND OF THE INVENTION

Research for new pharmaceuticals, medical treatments, and diagnostics to help cure many medical conditions is performed by commercial companies and research universities around the world. In order to perform this research, the labs need subjects that have the medical condition to be cured. It is known that particular medical conditions are present when the DNA of a subject does not contain or does contain a specific gene sequence. For years people have been constructing knockout/knockin models where a DNA sequence of a wild type subject incorporates and/or eliminates specific gene sequences (modifications). The subject may be a mouse, rat, fish, bacteria, yeast, pig, or human. In order to place the modification properly in the wild type DNA sequence, targeting vector components containing a left arm, the modification, and a right arm are selected. The left arm and the right arm are DNA sequences that match the wild type DNA sequence at particular positions. The wild type DNA sequence between the left arm and the right arm, herein called the target region, is replaced by the modification in order to create the knockout/knockin model.

However, because there are many different wild type sequences and targeting vectors available, one cannot be sure that the created knockout/knockin model will generate the correct subject for the research being performed. In order to ensure the model is correct for the research, the researcher must sift through pages of DNA sequences. Although it is typical to represent the DNA sequences in a graphical format, these formats cannot be used to ensure the model is correct because they do not show the wild type DNA sequences proportionate to the targeting vector and do not show the target region accurately aligned with the modification.

Accordingly, it would be desirable to provide a display that provides an accurate representation of the modification process and information to the user that assures the user that the created knockout/knockin model will generate the correct subject for the research being performed.

### SUMMARY OF THE INVENTION

The present invention is a computer-implemented method for imaging DNA sequences in gene-targeting processes. The present invention is also a DNA computer and/or a DNA server computer that performs the method of the present invention. In accordance with one embodiment of the present invention, the method includes receiving from a user computing device a wild type sequence comprising DNA sequences, and targeting vector components including DNA sequences of a left arm, a modification, and a right arm. The method further includes determining a target region based on the wild type sequence and the targeting vector. The method further includes determining a left arm icon algorithmically proportionate with the length of the left arm DNA sequence, a target region icon algorithmically proportionate with the length of the target region DNA sequence, a right arm icon algorithmically proportionate with the length of the right arm DNA sequence, and a modification icon algorithmically proportionate with the length of the modification DNA sequence. The method further includes generating a wild type representation including an ordered series of at least the left arm icon, the target region icon, and the right arm icon. The method further includes generating a second vector including an ordered series of at least the left arm icon, the modification icon, and the right arm icon. The method further includes generating a graphical display image incorporating the wild type representation and the second vector; and transmitting the graphical display image to the user computing device.

In another embodiment, the method may further include determining a first outside arm and a second outside based on the wild type sequence and the targeting vector; and determining a first outside arm icon algorithmically proportionate with the length of the first outside arm DNA sequence and a second outside arm icon algorithmically proportionate with the length of the second outside arm DNA sequence. The wild type representation and possibly the second vector may contain the first outside arm icon before in the ordered series the left arm icon and the second outside arm icon after in the ordered series the right arm icon. In this embodiment the second vector is a graphical representation of a knockout/knockin model.

In another embodiment, the graphical display image further includes a third vector comprising an ordered series of the first outside arm icon, the left arm icon, the modification icon, the right arm icon, and the second outside arm icon. In this embodiment, the second vector is a graphical representation of the targeting vector components and the third vector is a graphical representation of a knockout/knockin model.

In another embodiment, the modification icon of the second vector and the modification icon of the third vector are visually aligned with the target region icon of the wild type representation.

In one embodiment, the wild type sequence received from the user computing device is a wild type label representing the DNA sequences and the method further includes determining the DNA sequences associated with the wild type label. Similarly the targeting vector components received from the user computing device may be a targeting vector label representing the targeting vector components' DNA sequences and the method further includes determining the targeting vector components associated the targeting vector label.

In another embodiment the wild type representation and the second vector may be represented by exons. In this embodiment, the method further includes receiving from the user computing device a display preference for the modification sequence icon and a cDNA input, determining a plurality of exons with associated exon locations and associated exon sizes for each of the left arm, the right arm, and the target region using the cDNA input; representing on the graphical image display the left arm icon comprising the plurality of left arm exons at their associated exon locations and associated exon sizes; representing on the graphical image display the right arm icon comprising the plurality of right arm exons at their associated exon locations and associated exon sizes; representing on the graphical image display the target region icon comprising the plurality of target region exons at their associated exon locations and associated exon sizes; and representing on the graphical image display the modification icon comprising the user display preference.

In another embodiment, the method includes receiving from the user computing device sequence motif components, determining sequence motif icons associated with the sequence motif components, determining sequence motif locations associated with the sequence motif icons, and representing on the graphical display image the sequence motif icons at the associated sequence motif locations. The sequence motifs received from the user may include, but are not limited to, restriction enzymes, oligos, southern enzymes, repetitive sequences and probes. In one embodiment when one of the sequence motif components received from the user computing device is a probe, the method may further include determining at least one southern enzyme candidate associated with each of the probes, transmitting to the user computing device the at least one southern enzyme candidate for each of the probes, receiving from the user computing device a selection from the at least one southern enzyme candidate for each of the probes, determining a first and second southern enzyme icon associated with the selected southern enzyme candidate for each of the probes, determining a first southern enzyme location associated with the first southern enzyme icon and a second southern enzyme location associated with the second southern enzyme icon for each of the probes, and representing on the graphical display image the first southern enzyme icon at the first southern enzyme location and the second southern enzyme icon at the second southern enzyme location for each of the probes.

In another embodiment, the method may include generating a DNA sequence report. In another embodiment, the method may include representing on the graphical display image, text descriptions of the different icons in near proximity to the icons. In another embodiment the user computing device is provided with instructions to enable the user computing device to display an object when an associated icon is selected. The icon may be selected by hovering over the icon or by clicking on the icon.

The method may be executed on a computer that (1) allows a user to input wild type sequences, targeting vectors, and other information as described above; and (2) displays to the user the resulting graphical display image. Alternatively, the method may be executed by a DNA server computer that receives from a user computing device wild type sequences, targeting vectors, and other information over the Internet or an intranet; and transmits to the user computing device the resulting graphical display image over the Internet or an intranet.

### BRIEF DESCRIPTION OF THE DRAWING

The above and other advantages of the present invention will be apparent upon consideration of the following detailed description, taken in conjunction with the accompanying drawing, in which like reference characters refer to like parts throughout, and in which:

FIG. 1 illustrates a graphical display image of one embodiment of the present invention;

FIG. 2 illustrates a graphical display image of one embodiment of the present invention;

FIG. 3 shows a block diagram of the DNA server computer system of the present invention;

FIG. 4 shows a block diagram of the DNA computer of the present invention;

FIG. 5 shows a flowchart of the method of imaging a DNA sequence;

FIG. 6 shows a DNA sequence report of one embodiment of the present invention;

FIG. 7 shows a graphical display image of one embodiment of the present invention showing exons;

FIG. 8 shows a flowchart for determining icons;

FIG. 9 shows a flowchart for determining sequence motif icons;

FIG. 10 shows a flowchart for determining the southern enzymes associated with a probe;

FIG. 11 shows a graphical display image of one embodiment of the present invention showing the sequence motifs; and

FIG. 12 shows a diagram of one embodiment where text descriptions and objects are incorporated into the graphical display image.

### DETAILED DESCRIPTION

The present invention includes a method of imaging DNA sequences in gene-targeting processes to allow a user to know that a modification will produce the required knockout/knockin model. The method includes producing a graphical display image that allows a user to accurately know the components of a selected wild type sequence and a selected modification and the placement of those components. Icons that are algorithmically proportional to the DNA sequences represent the components. The graphical display image may also show accurate locations of sequence motifs, including, but not limited to, restriction enzymes, oligos, probes, repetitive sequences, and southern enzymes, to help the user design methods for producing the knockout/knockin model in the lab. The sequence motifs are represented by different icons. Furthermore, DNA sequence reports that show a listing of the DNA base pairs with the components, modifications, and sequence motifs emphasized allow the user to further verify the modification process. Lastly, the user may display text information associated with the icons for further information. This information may facilitate quality control because the user can be alerted to problems and insights found by other researchers. Moreover, the user may design new unknown targeting vectors using the tools presented herein. The method of the present invention may be used with DNA of mice, rats, fish, bacteria, yeast, pigs, or humans.

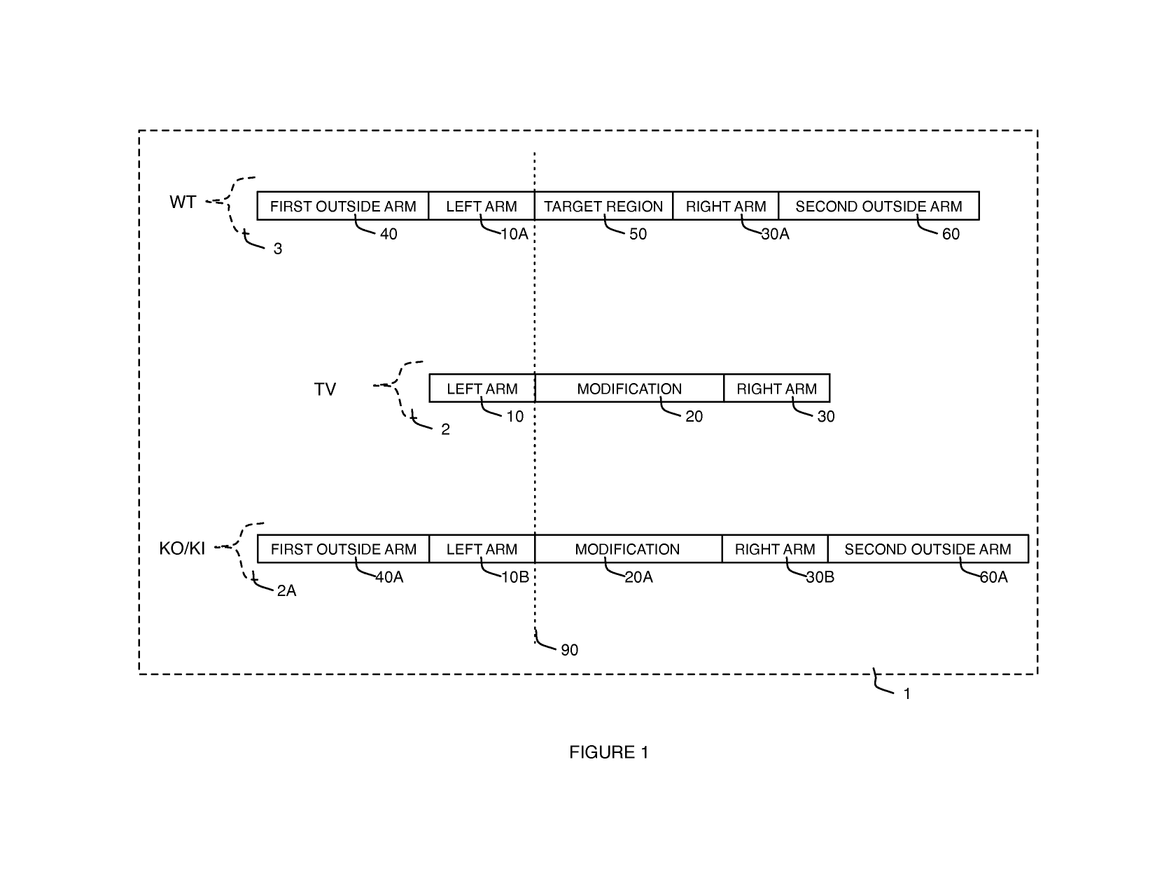

FIG. 1 illustrates a graphical display image 1 where three DNA sequences 2, 2A, and 3 are represented. The first is a wild type representation 3, which includes a first outside arm icon 40, a left arm icon 10A, a target region icon 50, a right arm icon 30A and a second outside arm icon 60. The second vector 2 is a representation of a targeting vector, which includes a left arm icon 10, a modification icon 20, and a right arm icon 30. Lastly, the third vector 2A is a representation of a knockout/knockin model, which includes a first outside arm icon 40A, a left arm icon 10B, a modification icon 20A, a right arm icon 30B, and a second outside arm icon 60A. The left arm and the right arm may also be called the long arm and the short arm or the 5′ arm and the 3′arm. The names of the arms can be interchanged according to the design.

As referred to herein the general term “icons” includes any type of icon including the icons described above and those described below. One feature of the present invention is that the icons that are representative of DNA sequences are algorithmically proportionate in size on the graphical image display to the DNA sequences they represent. The determination of the icons is further described below.

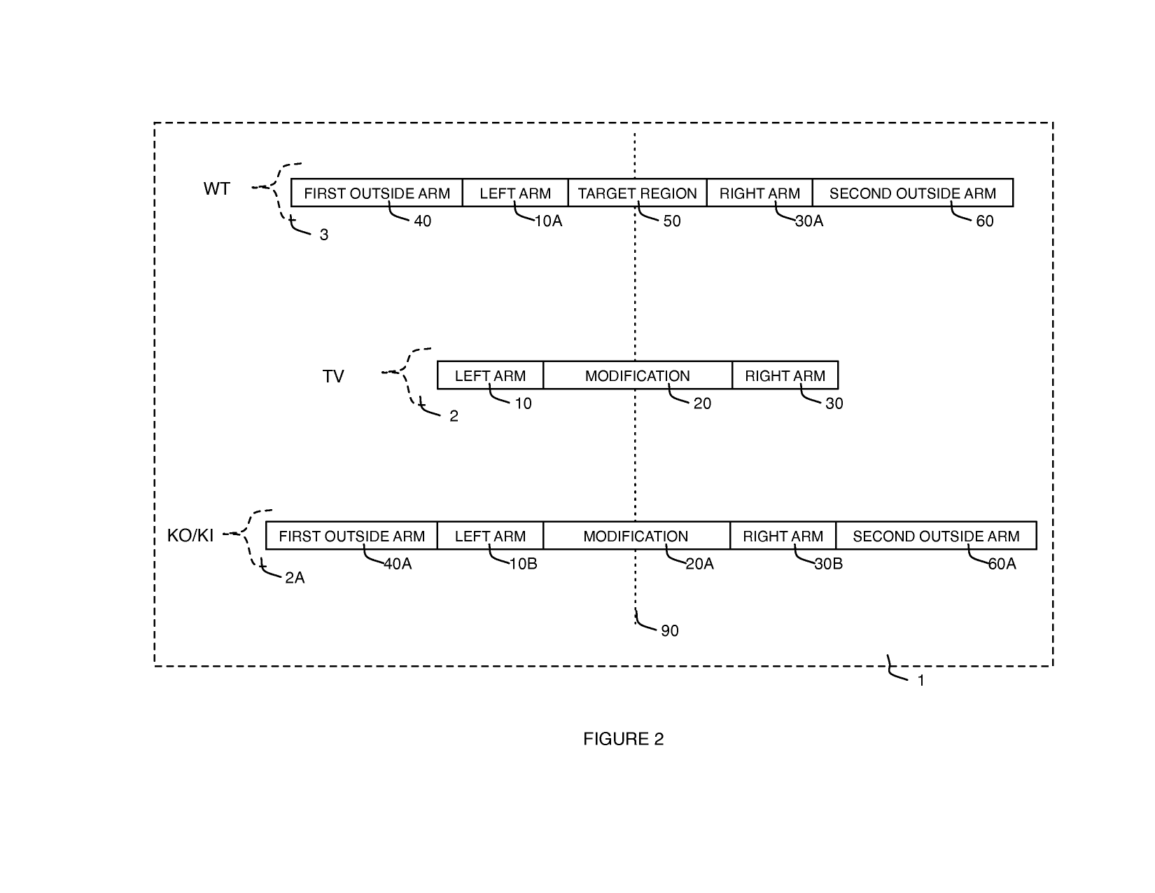

Although FIG. 1 shows the wild type representation 3 containing a first outside arm icon 40 and a second outside arm icon 60, in some embodiments these icons may not be present because the user may only be interested in the modification region. Furthermore, although FIG. 1 shows the graphical display image 1 containing three vectors, 2, 2A, and 3, the graphical display image 1 may contain only two vectors in some embodiments; for example, the wild type representation 3 and the targeting vector 2, or the wild type representation 3 and the knockout/knockin model 2A. Whether the graphical display image 1 contains two or three DNA sequence representations, the modification icon 20 or 20A may be visually aligned with the target region icon 50, as shown by 90. In FIG. 1 the visual alignment 90 is left justified, while in FIG. 2, the visual alignment 90 is center justified. The visual alignment may also be circularly aligned (not shown) or right justified (not shown).

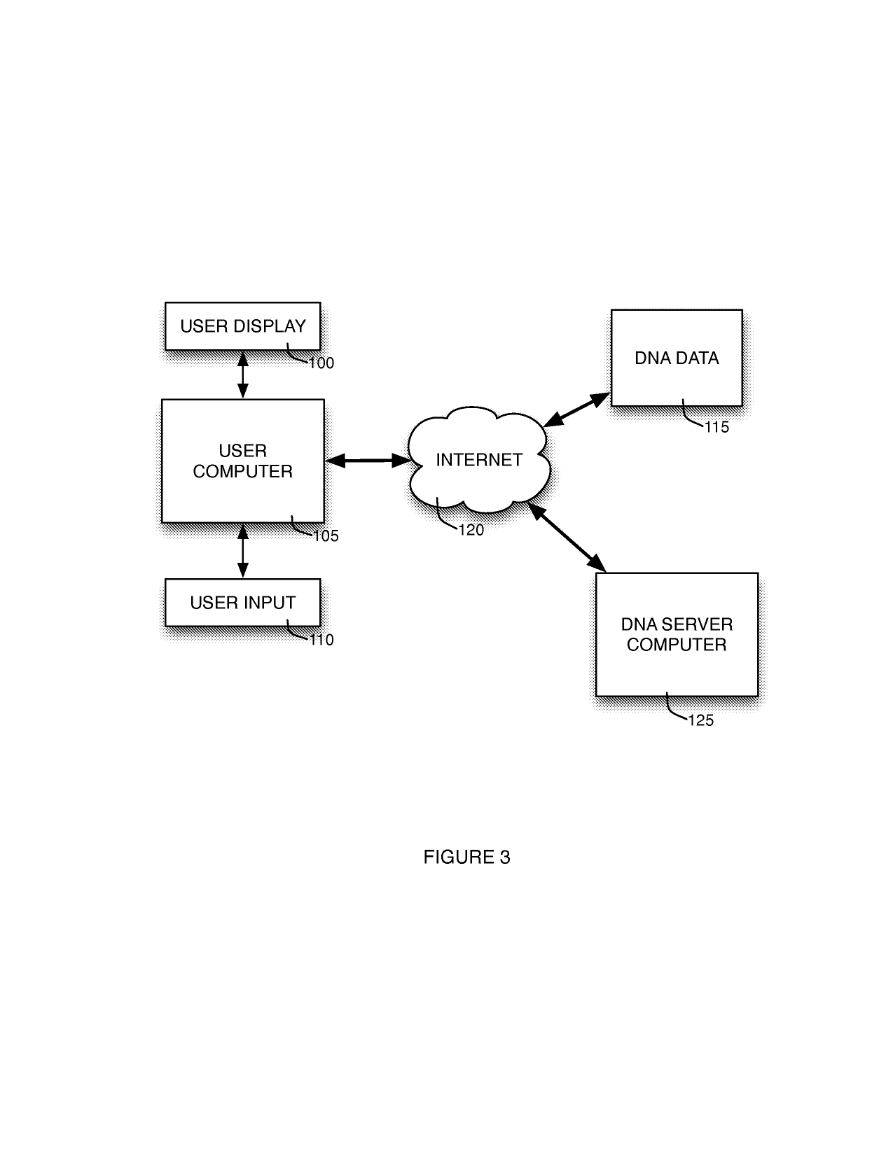

FIG. 3 shows a DNA server computer 125. In this embodiment of the present invention a user (not shown) may input information into a user computer 105 via a user input 110. The user computer 105 may access the Internet 120 (this may also be an intranet) and connect to a DNA server computer 125, as well known to one skilled in the art. The user may then populate data fields required by the DNA server computer 125 with for example, a wild type DNA sequence and targeting vector components. The DNA server computer 125 will generate a graphical display image 1 as described below, which will be transmitted back to the user computer 105 and displayed to the user via the user display 100, as known by one skilled in the art. This transmission (and all others) may utilize compression techniques known to one skilled in the art. The DNA server computer 125 may access required DNA data 115 through the Internet (or intranet), as known by one skilled in the art, in order to generate the graphical display image 1. This DNA data 115 may include wild type DNA sequences, targeting vector components, cDNA sequences, and sequence motif information.

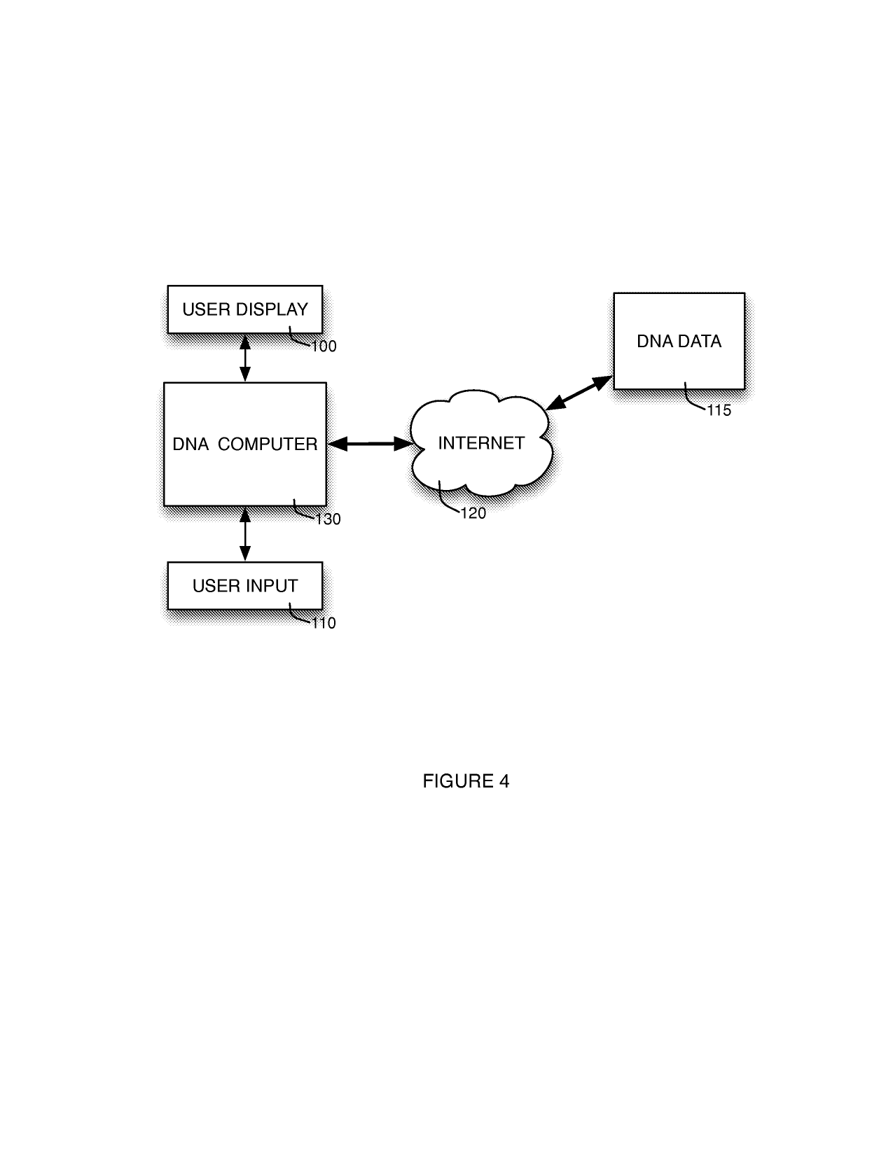

FIG. 4 shows a DNA computer 130. In this embodiment, the program to generate the graphical display image 1 is resident on a DNA computer 130. In this embodiment, a user may input information into the DNA computer 130 via a user input 110. The user may then populate data fields with for example, the wild type DNA sequence and targeting vector components. The DNA computer 130 will generate the graphical display image 1 and display it to the user via the user display 100. The DNA computer 130 may access required DNA data 115 through the Internet, as known by one skilled in the art, in order to generate the graphical display image 1.

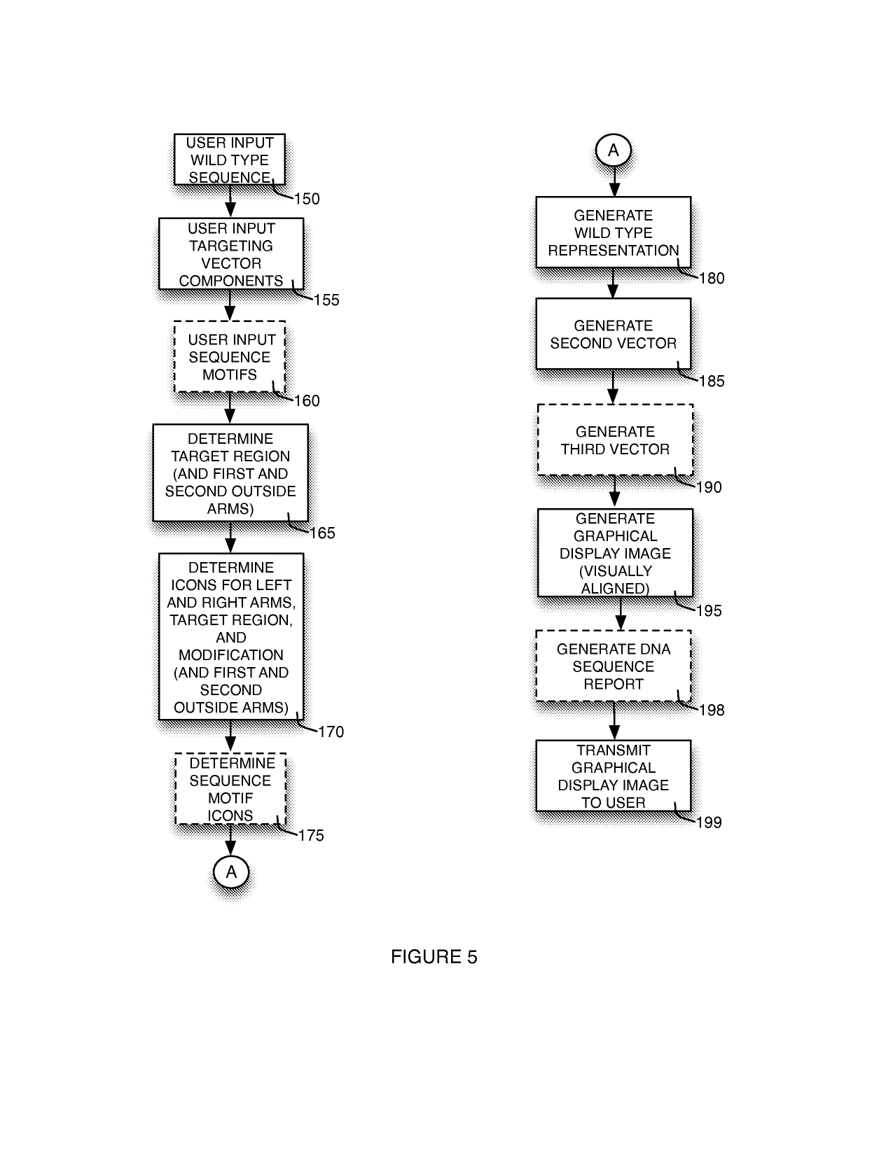

FIG. 5 illustrates a flowchart for implementing the method of imaging a DNA sequence in accordance with the DNA server computer 125 embodiment of the present invention. One skilled in the art will understand that the steps described in this embodiment may be implemented on a DNA computer 130 as described above. The steps that are represented by dashed boxes or that are in parentheses are present in some embodiments and not present in other embodiments. In step 150, a wild type sequence is received from a user computing device 105. The wild type sequence received from the user computing device 105 may be a series of DNA sequences or a label of a specific wild type. If a label is given by the user, the series of DNA sequences represented by the specific wild type label may be determined from a look up table or from a gene library (DNA data 115) accessed through the Internet 120 as known by one skilled in the art.

In step 155, the targeting vector components are received from the user computing device 105. The targeting vector components may include the left arm, the right arm, and the modification. The targeting vector components received from the user computing device 105 may also include the first and the second outside arms. The modification may include a Neo cassette, a LoxP, FRT, Point mutation, GFP, or a self designed modification as described below. Conversely, the targeting vector components may be a label of a specific modification. If a label is given by the user, the targeting vector components may be determined from a look up table or from a gene library accessed through the Internet 120 as known by one skilled in the art.

In step 160, if the user desires, the user may input sequence motifs related to the targeting vector components. These may include, but are not limited to, restriction enzymes, oligos, probes, repetitive sequences and southern enzymes. The user inputs the sequence motifs by selecting from a list of available sequence motifs displayed to the user. The sequence motifs are further described below.

In step 165, a target region is determined in the wild type sequence. This step may also include determining a first outside arm and a second outside arm. The first outside arm, the second outside arm are input by the user, as described in step 155, or are determined by matching the left arm within the wild type sequence and the right arm within the wild type sequence. The DNA sequences of the wild type sequence that are within the left and right arms are the target region while the DNA sequences outside the left arm and the right arm are the first outside arm and the second outside arm, respectively. The left arm and right arm may be located in the wild type sequence by comparing the left arm DNA sequences to the wild type DNA sequences and comparing the right arm DNA sequences to the wild type DNA sequences, as well known to one skilled in the art.

In step 170 icons are determined for the first outside arm (in one embodiment), the left arm, the target region, the right arm, the second outside arm (in one embodiment), and the modification are selected. The icons include, as shown in FIG. 1, the first outside arm icon 40, which is algorithmically proportionate with the length of the first outside arm DNA sequence; a left arm icon 10, which is algorithmically proportionate with the length of the left arm DNA sequence; a target region icon 50, which is algorithmically proportionate with the length of the target region DNA sequence; a right arm icon 30, which is algorithmically proportionate with the length of the right arm DNA sequence; a second outside arm icon 60, which is algorithmically proportionate with the length of the second outside arm DNA sequence; and a modification icon 20, which is algorithmically proportionate with the length of the modification DNA sequence. Any algorithm-based association between the length (number) of the nucleotides and the size of the icon is considered to be algorithmically proportionate. For example but not limited to: when one nucleotide (DNA base pair in the DNA sequence) is equal to one pixel, when one nucleotide is some unit of pixels, or when one nucleotide is a fraction of a pixel. In addition, the icon size, which is representative of the number of nucleotides, may be represented in the following manner: one nucleotide (or some other amount) may be added or subtracted from the total number of nucleotides that form the icon size, the icon size may be logarithmically correlated to the total number of nucleotides, or the total number of nucleotides in the icon may be squared. This step will be described in more detail below.

If the user has selected sequence motifs, the icons and the locations of the selected sequence motifs are determined, step 175. This step will be further described below.

In step 180 a wild type representation 3 is generated from the wild type sequence including a first outside arm icon (in one embodiment), a left arm icon 10A, a target region icon 50, a right arm icon 30A, and a second outside arm icon 60 (in one embodiment). In step 185 a second vector 2 is generated including at least the left arm icon 10, the modification icon 20, and the right arm icon 30. In this embodiment the second vector is a graphical representation of the targeting vector 2. However, in a different embodiment the graphical display image 1 may contain the wild type representation 3 and the knockout/knockin model 2A. The second vector in this embodiment includes the first outside arm icon 40A, the left arm icon 10B, the modification icon 20A, the right arm icon 30B and the second outside arm icon 60A. In another embodiment the wild type representation 3 and a second vector 2 and a third vector 2A are generated, step 190. In this embodiment the second vector is a graphical representation of the targeting vector 2 and the third vector 2A is a graphical representation of a knockout/knockin model 2A.

In step 195 the graphical display image 1 is generated to include the wild type representation 3, the second vector 2 or 2A (and the third vector 2A in one embodiment). In one embodiment, the modification icon(s) 20 (and/or 20A) may be visually aligned with the target region icon 50 of the wild type representation 3. This is shown by dashed line 90. The visual alignment may show the modification 20 (and/or 20A) left aligned with the target region 50, as shown in FIG. 1; center aligned, as shown in FIG. 2, circularly aligned, or any other alignment that may be useful to the user.

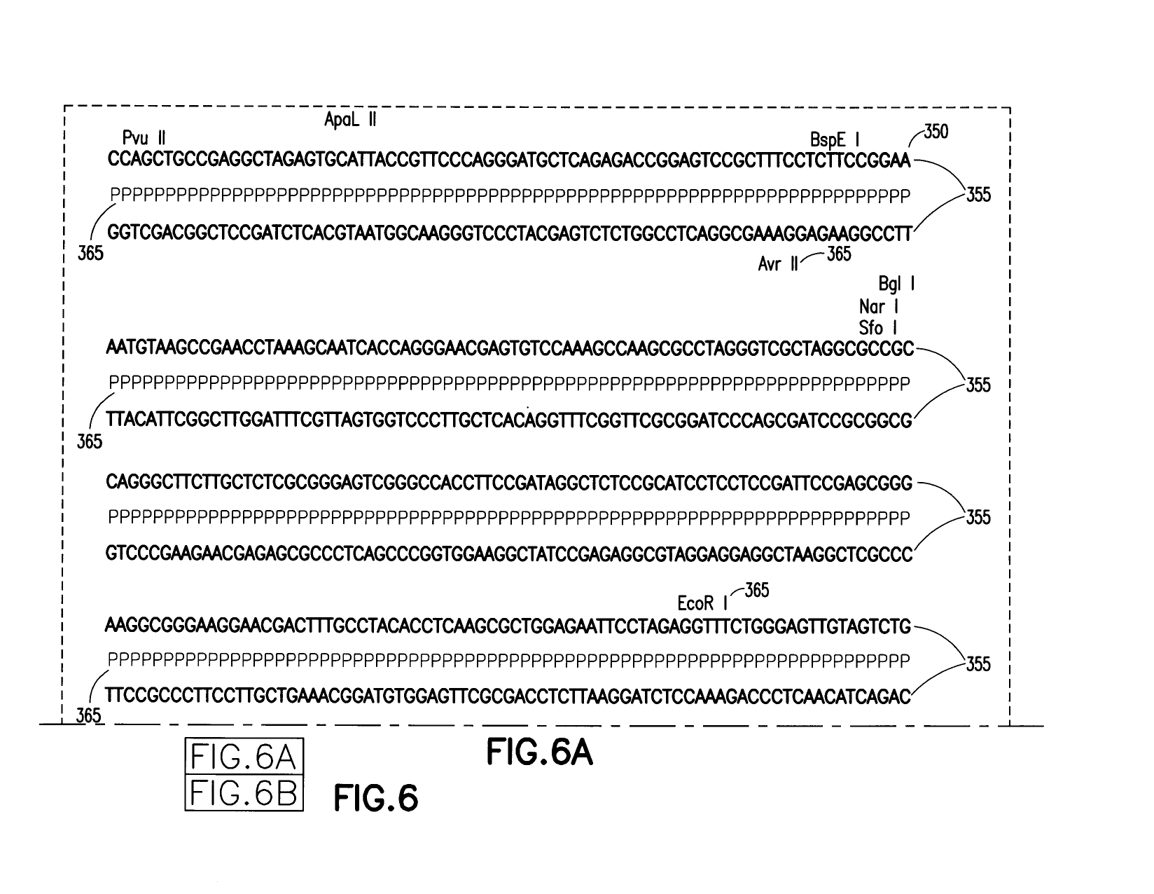

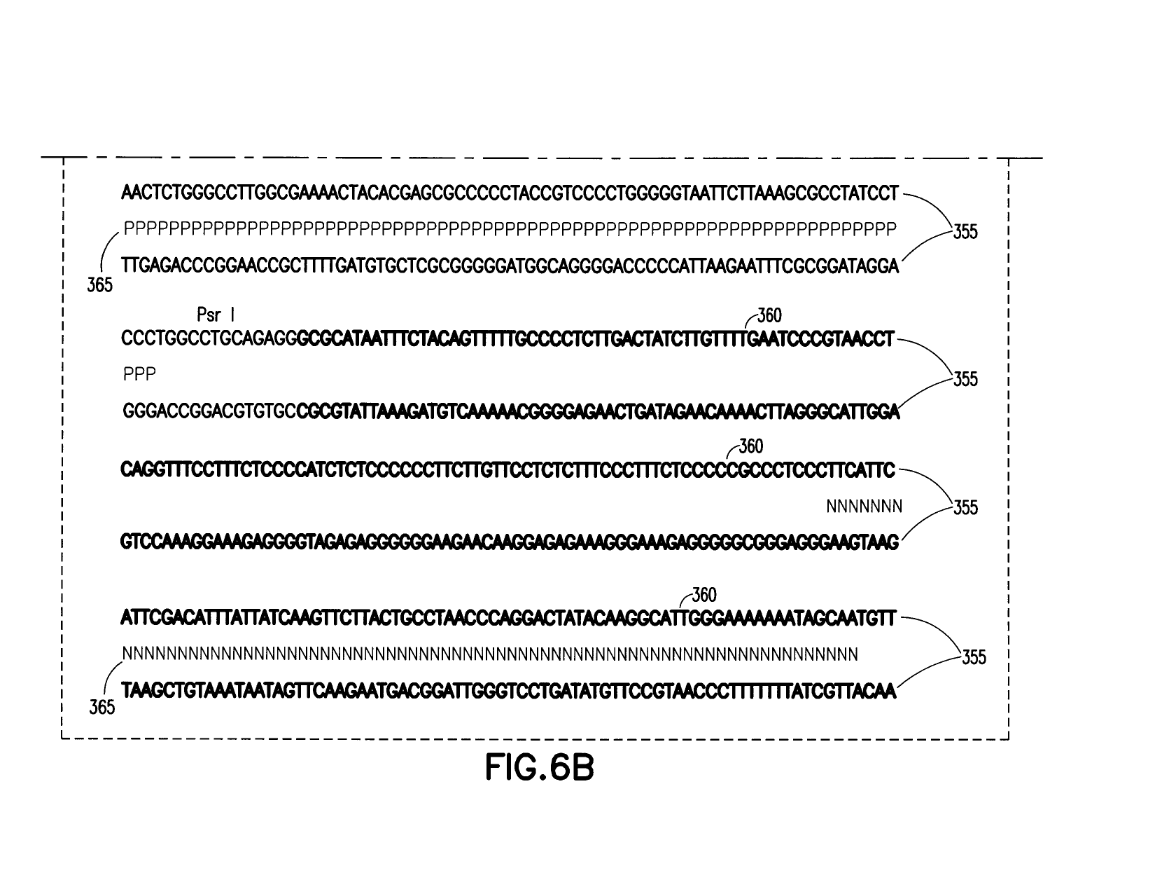

In step 198 a DNA sequence report may be generated if the user requests the report. FIG. 6 shows an example of a DNA sequence report 350. The DNA sequence report 350 is a long textual list of all the knockout/knockin DNA sequences. FIG. 6 shows one page of the DNA sequence report 350, however this report may contain many more pages. The DNA sequence report 350 allows the user to see in more detail the information shown on the graphical display image 1. The report 350 contains a listing of the DNA base pairs 355. Certain bases pairs may be emphasized 360 and certain symbols 365 may be shown to represent the first outside arm, the second outside arm, the left arm, the right arm, the modifications, the repetitive sequences, and the sequence motifs. For example, the first and second outside arms may be shown in plain text, the left arm may be shown in bold and italic, the right arm may be underlined, the exons may be marked with “̂”, the probes may be marked with “p”, the repetitive sequences may be marked with “N”, the Neo may be marked in red, the point mutation may be marked in bold red, the LoxP may be marked with “L”, the FRT may be marked with “F”, and the oligo may be marked with “o”.

In step 199 the graphical display image 1 is transmitted to the user computing device. In the embodiment where the DNA sequence report 350 is generated, the DNA sequence report 350 may be transmitted to the user computing device 105 in addition to the graphical display image 1 or instead of the graphical display image 1. The transfer may be accomplished by a local area network, a wide area network such as the Internet or by wireless communications, all as well known in the art.

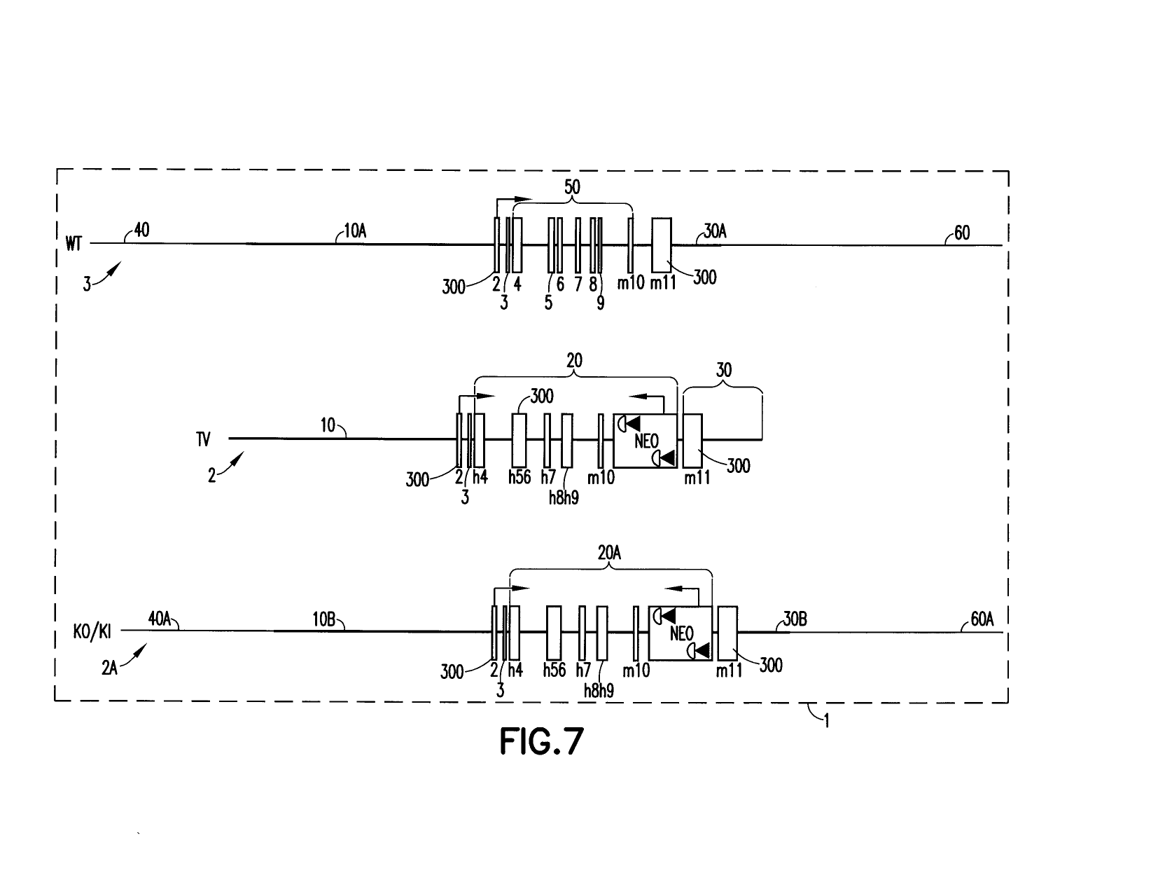

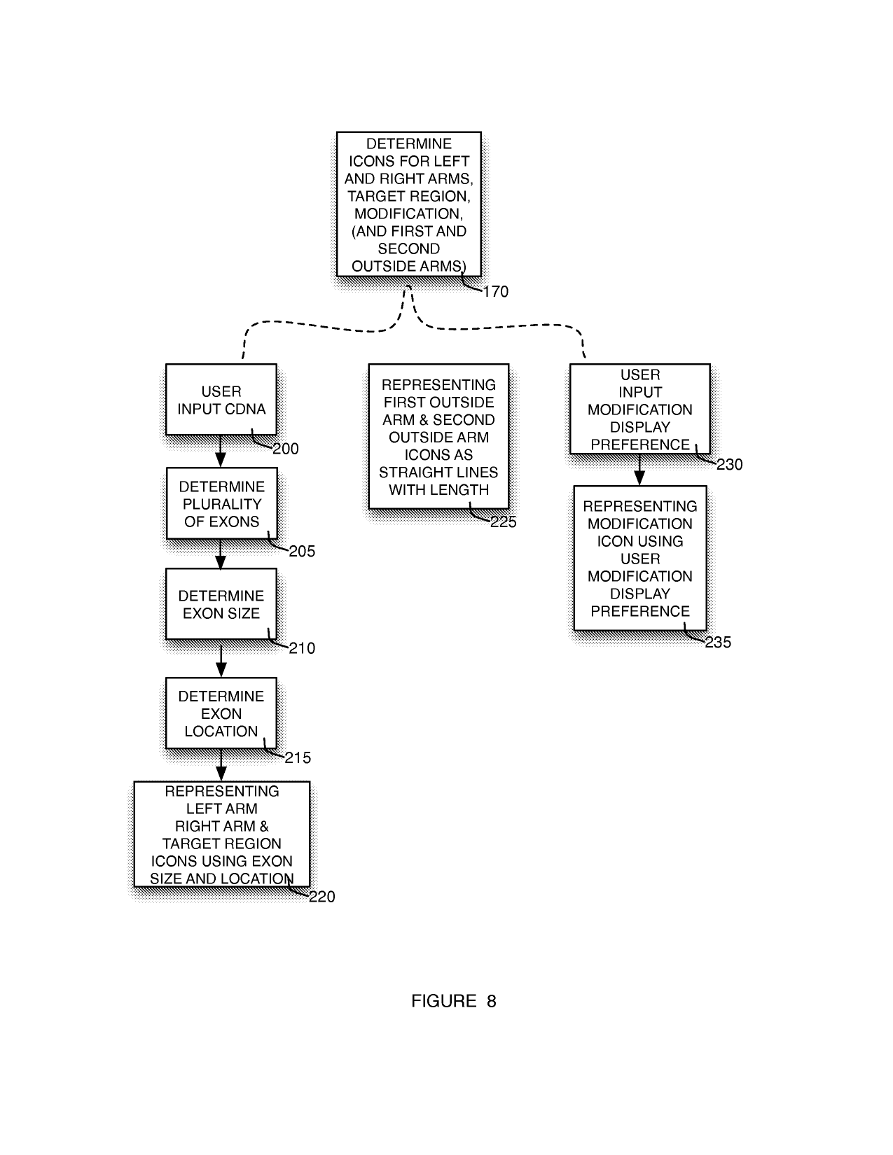

For a more detailed description of selecting the icons (step 170), please refer to FIG. 7 and FIG. 8. FIG. 7 shows an embodiment where the icons in the wild type representation 3, the second vector 2, and the third vector 2A include exons 300. FIG. 8 shows a flowchart describing how the exons 300 are determined. In this embodiment, the method further includes step 200, receiving from the user computing device a cDNA input. The method may further include step 205, determining a plurality of exons 300 in the wild type sequence by comparing the cDNA input to the wild type sequence. The method further includes the steps of determining for the plurality of exons an associated exon size, step 210, and an associated exon location, step 215. The method also includes the step of including in the left arm icon 10, the right arm icon 30, and the target region icon 50 the exons at the determined exons sizes and exon locations, step 220. The exon sizes and locations are determined by matching a block or a sequence of nucleotides in the cDNA to the nucleotides of the wild type DNA sequence. The number of matching nucleotides determines the size of the exons. The program keeps track of the locations of the matching nucleotides in the wild type sequence location to determine the location of the exons. Where the nucleotides in the wild type DNA sequence do not match the cDNA sequences, lines representing introns are located.

In the embodiment shown in FIG. 7, the first outside arm 40 and the second outside arm 60 are represented by straight lines with lengths algorithmically proportional to the number of nucleotides in the outside arm DNA sequences input by user, step 225. However, the outside arms, 40 and 60, may include exons or other features. Also in this embodiment, the method further includes receiving from the user computing device a user modification display preference, step 230. The modification icon 20 is represented by the user modification display preference, step 235. The display preference is selected by the user by inputting DNA sequences for the modifications, which may include a Neo cassette, a LoxP, FRT, Point mutation, GFP, hypromycine cassette, puromycine cassette, human sequences, human genes, LacZ, cDNA, luciferase, 2a peptide, IRES, promotors, poly-A, any protein-coding sequences, or a self designed modification.

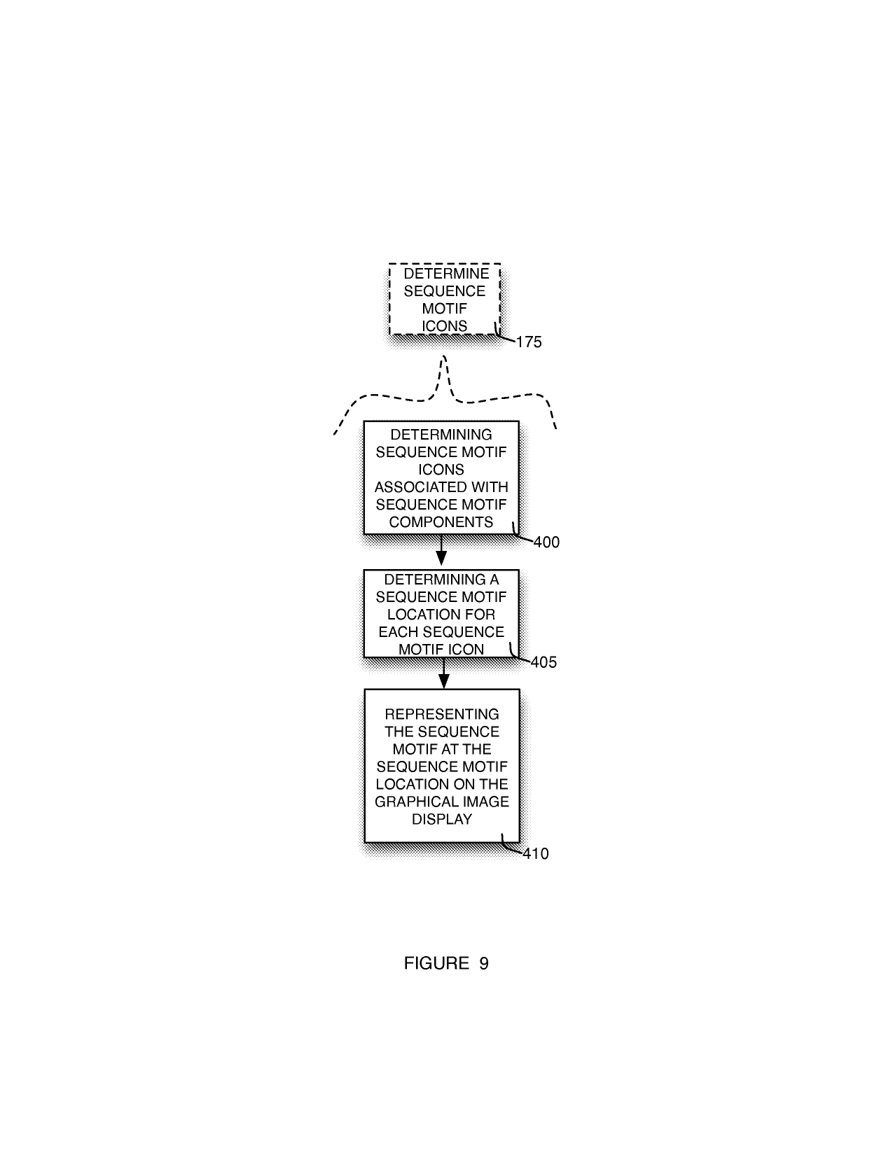

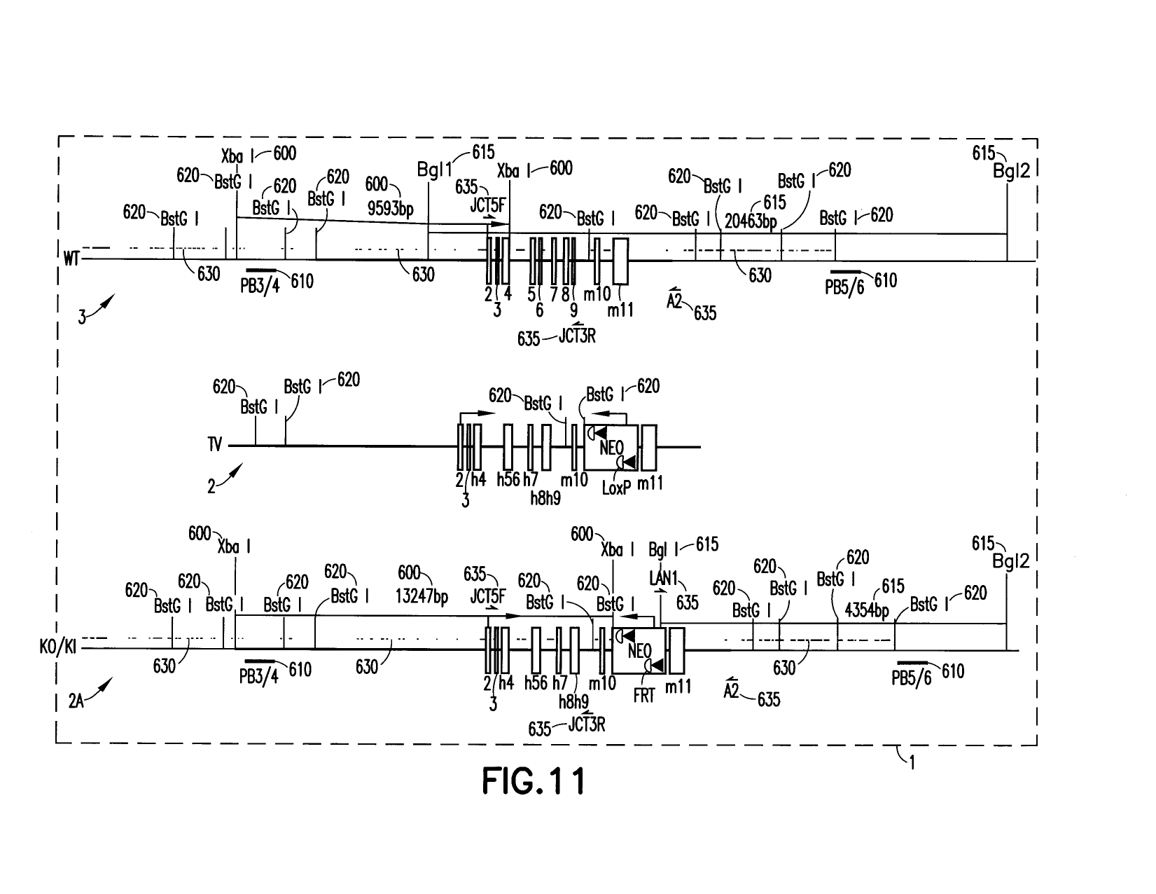

A more detailed description of determining the sequence motif icons (step 175) will now be described. In this embodiment the user has selected one or more sequence motifs to be displayed on the graphical display image (step 160). Referring to FIG. 9, this embodiment includes the step of determining sequence motif icons associated with the sequence motif components 400 input by the user. The sequence motif icons are shown in FIG. 11 and may include restriction enzymes 620, oligos 635, southern enzymes 600, repetitive sequences 630 and probes 610. The sequence motif icons may be represented by symbols or characters selected by the user or symbols or characters programed by the system designer. The sequence motif icons may include the location of the nucleotides where the sequence motif is located.

Referring back to FIG. 9, the next step is determining sequence motif locations for each sequence motif icons, step 405. The sequence motif locations are determined based on locating the sequence motif DNA sequence in any of the wild type sequence, the DNA sequence of the second vector, or the DNA sequence of the third vector. The last step 410 is representing the sequence motif icons at its associated sequence motif locations on the graphical display image. Computing the location of the sequence motif icon on the graphical display image is accomplished by determining an algorithmically proportionate sequence motif icon location to the determined sequence motif locations determined in step 405.

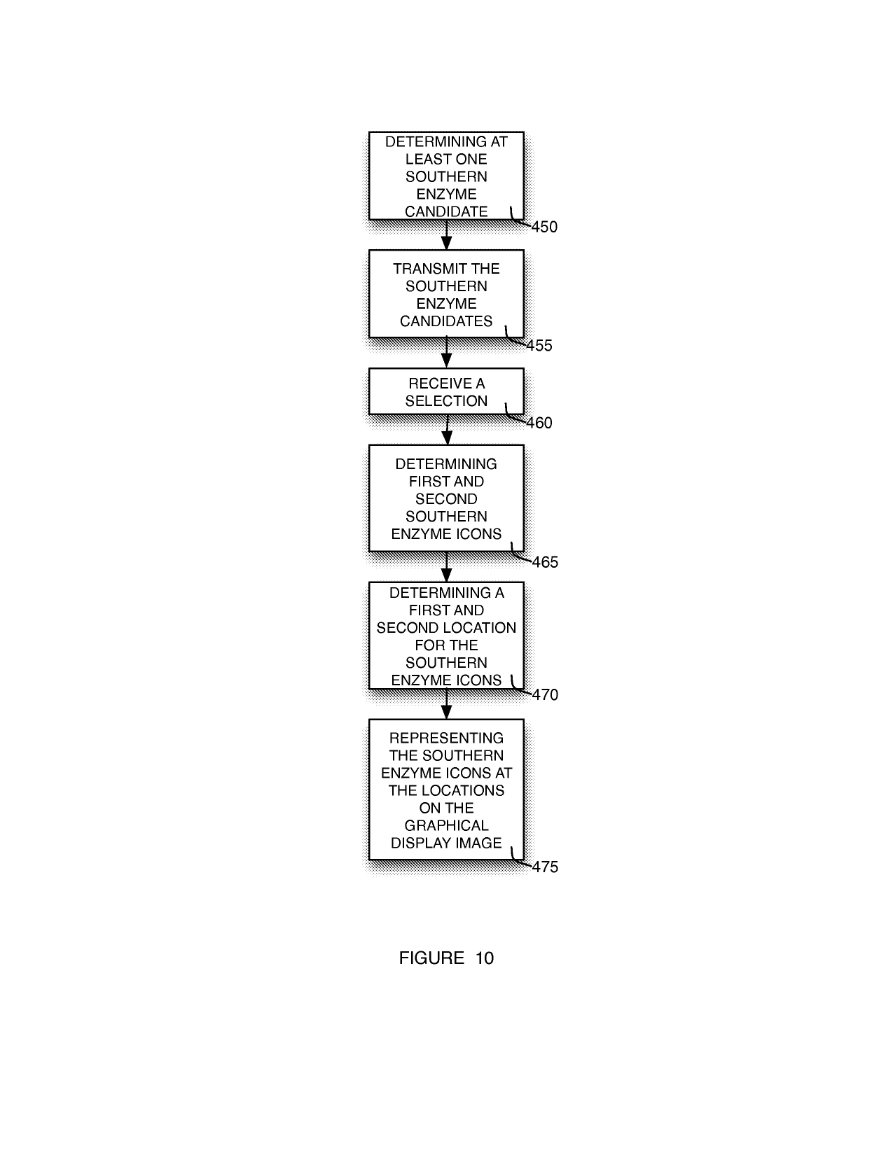

Referring to FIG. 10, when the user selects probes 610 as the sequence motif, southern enzymes candidates are suggested to the user for each of the probes 610. The user normally designs three kinds of probes 610: external probes, internal probes, and modification probes. The external probes are selected to be in the outside arms 40 and 60; the internal probes are designed in the arms 10 and 30; and the modification probes are designed in the modification 20. After the probes 610 are selected, the method further includes the steps of determining at least one southern enzyme candidate associated for each of the probes, step 450. The southern enzymes candidates are selected so that they do not cut the probe 610 and have two adjacent cutting sites on the different sides of the probe 610 in both the wild type sequence and the knockout/knockin model. In addition, for the external probes and internal probe, assuming the two adjacent cutting sites of the enzyme would produce DNA sequences with x base pairs in the wild type sequence and y base pairs in the knockout/knockin model, the absolute value of x minus y should be greater than a predefined integer number of base pairs, e.g. 100 base pairs. The internal probes have an additional requirement that the two adjacent cutting sites of the enzyme should be outside of the left or right arm (depending on in which arm the probe is located). This applies for both the wild type sequence and the knockout/knockin model. Lastly, for the modification probes one of the cutting sites should be outside of either the left arm or the right arm. The user specifies which arm the cutting site should be outside of when the user selects the sequence motif components.

Once the southern enzyme candidates associated for each of the probes is determined, they are transmitted to the user computing device, step 455. Next the user selects at least one southern enzyme candidate for each of the probes, step 460. Next a first and second southern enzyme icon, step 465, and locations associated with the selected southern enzyme candidate, step 470, for each of the probes is determined similarly to the sequence motif location. Finally, in step 475, the first southern enzyme icon at the first southern enzyme location and the second southern enzyme icon at the second southern enzyme location for each of the probes are represented on the graphical display image similarly to the sequence motif icons.

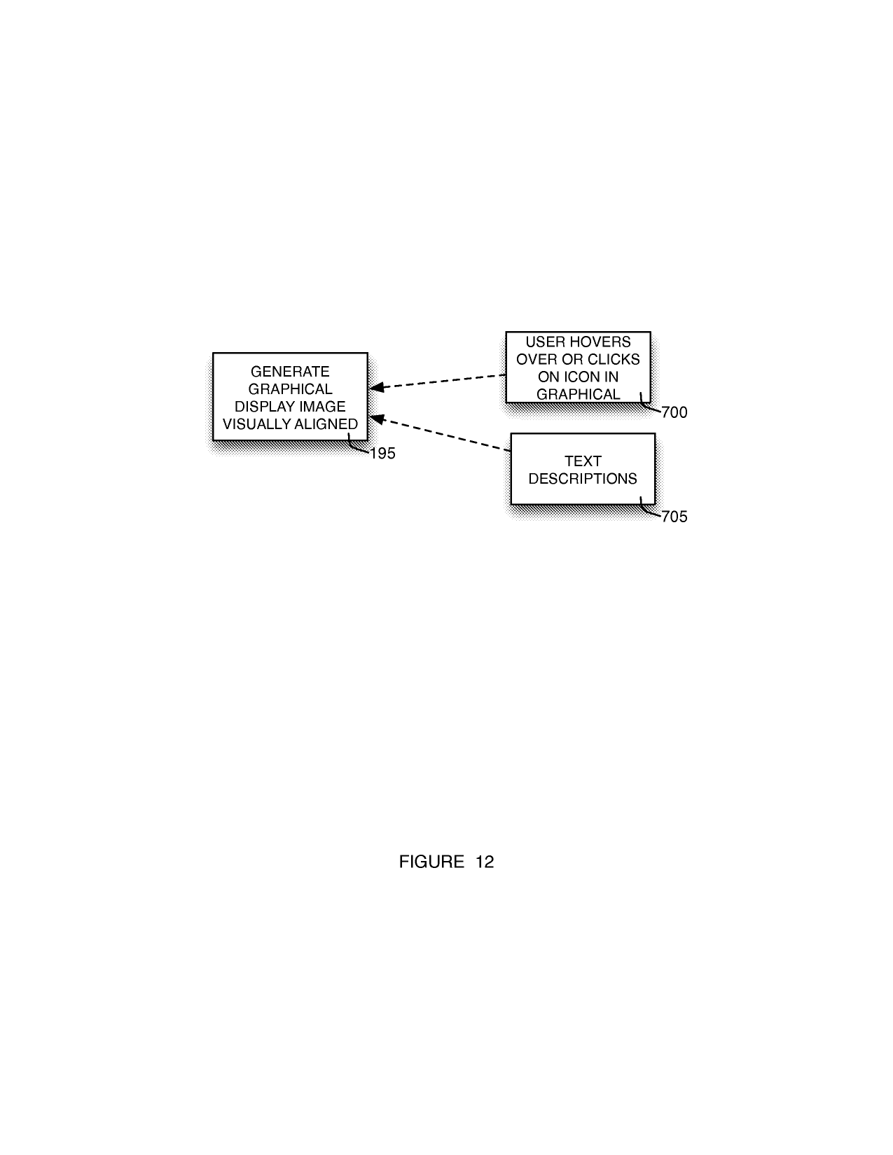

Referring to FIG. 12, in another embodiment, the method includes representing on the graphical display image 1, text descriptions of the different icons in near proximity to the icons, step 705. The text descriptions include names of the sequence motifs, sizes of the icons, wild type names, targeting vector names, the location of the icon relative to the first DNA base pair location or a set of pre-defined DNA base pair location. In addition, the user may want to add titles on the graphical display image for ease of future reference.

In another embodiment, the user computing device is provided with instructions to enable the user computing device to display an object when an associated icon is selected, as known to one skilled in the art. The icon may be selected by hovering over the icon or by clicking on the icon, step 700. The icon may also be selected though voice activation techniques. This information may increase the quality control of the DNA modification process because the user can be alerted to problems and insights found by other researchers. The objects displayed in this embodiment include: mouse identification information, quality control data, access to experimental data based on mouse, user group information, blog links, information on conferences, dates of information, webinar links.

Although particular embodiments of the present invention have been described above in detail, it will be understood that this description is merely for purposes of illustration. Alternative embodiments of those described hereinabove also are within the scope of the present invention. For example, alternative embodiments of the present invention can incorporate any one or more of the steps described with respect to FIGS. 5, 8, 9, 10, and 12. For example, in one embodiment of the present invention, the displaying of sequence motifs may include all the sequence motifs, one of the sequence motifs, or none of the sequence motifs. Also certain steps may be performed in a different order without changing the overall functioning of the method. For example, the user may input the targeting vector components, step 155, prior to the wild type sequence, step 150, or the second vector 2 may be generated before the wild type representation 3.

Furthermore, various embodiments described herein or portions thereof can be combined without departing from the present invention. For example, the modification to the wild type sequence may be only a removal of DNA sequences in the target region. In this embodiment the knockout/knockin model may not show the modification icon.

The above described embodiments of the present invention are presented for purposes of illustration and not of limitation, and the present invention is limited only by the claims which follow.

We claim:

1. A computer-implemented method for imaging DNA sequences in gene-targeting processes, comprising:
receiving from a user computing device a wild type sequence comprising DNA sequences, and targeting vector components comprising DNA sequences for a left arm, a modification, and a right arm;
determining a target region comprising DNA sequences using the wild type sequence and the targeting vector components;
determining a left arm icon algorithmically proportionate with a length of the left arm DNA sequence, a target region icon algorithmically proportionate with a length of the target region DNA sequence, a right arm icon algorithmically proportionate with a length of the right arm DNA sequence, and a modification icon algorithmically proportionate with a length of the modification DNA sequence;
generating a wild type representation comprising an ordered series of at least the left arm icon, the target region icon, and the right arm icon;
generating a second vector comprising an ordered series of at least the left arm icon, the modification icon, and the right arm icon;
generating a graphical display image comprising the wild type representation and the second vector; and
transmitting the graphical display image to the user computing device.

2. The method of claim 1, further comprising:
determining a first outside arm and a second outside arm using the wild type sequence and the targeting vector components; and
determining a first outside arm icon algorithmically proportionate with a length of the first outside arm DNA sequence and a second outside arm icon algorithmically proportionate with a length of the second outside arm DNA sequence.

3. The method of claim 2, wherein the wild type representation and the second vector further comprises the first outside arm icon before in the ordered series the left arm icon and the second outside arm icon after in the ordered series the right arm icon.

4. The method of claim 2, wherein the graphical display image further comprises a third vector comprising an ordered series of the first outside arm icon, the left arm icon, the modification icon, the right arm icon, and the second outside arm icon.

5. The method of claim 4, wherein the modification icon of the second vector and the modification icon of the third vector are visually aligned with the target region icon of the wild type representation.

6. The method of claim 1, wherein the wild type sequence received from the user computing device is a wild type label representing the DNA sequences and wherein the method further comprises determining the DNA sequences associated with the wild type label.

7. The method of claim 1, wherein the targeting vector components received from the user computing device is a targeting vector label representing DNA sequences and wherein the method further comprises determining the DNA sequences associated the targeting vector label.

8. The method of claim 1, further comprising:
receiving from the user computing device a cDNA input;
receiving from the user computing device a user display preference for the modification sequence icon;
determining a plurality of exons with associated exon locations and associated exon sizes for each of the left arm, the right arm, and the target region using the cDNA;
representing on the graphical image display the left arm icon comprising the plurality of left arm exons at their associated exon locations and associated exon sizes;
representing on the graphical image display the right arm icon comprising the plurality of right arm exons at their associated exon locations and associated exon sizes;
representing on the graphical image display the target region icon comprising the plurality of target region exons at their associated exon locations and associated exon sizes; and
representing on the graphical image display the modification icon comprising the user display preference.

9. The method of claim 1, further comprising:
receiving from the user computing device sequence motif components;
determining sequence motif icons associated with the sequence motif components;
determining sequence motif locations associated with the sequence motif icons; and
representing on the graphical display image the sequence motif icons at the associated sequence motif locations.

10. The method of claim 9, wherein the sequence motif is a repetitive sequence.

11. The method of claim 9, wherein the sequence motif is restriction enzymes.

12. The method of claim 9, wherein the sequence motif is oligos.

13. The method of claim 9, wherein the sequence motif is probes.

14. The method of claim 13, further comprising:
determining at least one southern enzyme candidate associated with each of the probes;
transmitting to the user computing device the at least one southern enzyme candidate for each of the probes;
receiving from the user computing device a selection from the at least one southern enzyme candidate for each of the probes;
determining a first and second southern enzyme icon associated with the selected southern enzyme candidate for each of the probes;
determining a first southern enzyme location associated with the first southern enzyme icon and a second southern enzyme location associated with the second southern enzyme icon for each of the probes; and
representing on the graphical display image the first southern enzyme icon at the first southern enzyme location and the second southern enzyme icon at the second southern enzyme location for each of the probes.

15. The method of claim 1, further comprising generating a DNA sequence report.

16. The method of claim 1, further comprising representing on the graphical display image text descriptions of icons in near proximity thereto.

17. The method of claim 1, further comprising providing to the user computing device instructions to enable the user computing device to display an object when an associated icon is selected.

18. The method of claim 17, wherein the icon is selected by hovering over the icon.

19. The method of claim 17, wherein the icon is selected by clicking the icon.

20. A DNA server computer for imaging DNA sequences in gene-targeting processes, the DNA server computer programmed to:
receive from a user computing device a wild type sequence comprising DNA sequences, and targeting vector components comprising DNA sequences for a left arm, a modification, and a right arm;
determine a target region using the wild type sequence and the targeting vector components;
determine a left arm icon algorithmically proportionate with a length of the left arm DNA sequence, a target region icon algorithmically proportionate with a length of the target region DNA sequence, a right arm icon algorithmically proportionate with a length of the right arm DNA sequence, and a modification icon algorithmically proportionate with a length of the modification DNA sequence;
generate a wild type representation comprising an ordered series of at least the left arm icon, the target region icon, and the right arm icon;
generate a second vector comprising an ordered series of at least the left arm icon, the modification icon, and the right arm icon;
generate a graphical display image comprising the wild type representation and the second vector; and
transmit the graphical display image to the user computing device.

21. The DNA server computer of claim 20, wherein the DNA server computer is further programmed to:
determine a first outside arm and a second outside arm using the wild type sequence and the targeting vector components; and
determine a first outside arm icon algorithmically proportionate with a length of the first outside arm DNA sequence and a second outside arm icon algorithmically proportionate with a length of the second outside arm DNA sequence.

22. The DNA server computer of claim 21, wherein the wild type representation and the second vector further comprises the first outside arm icon before in the ordered series the left arm icon and the second outside arm icon after in the ordered series the right arm icon.

23. The DNA server computer of claim 21, wherein the graphical display image further comprises a third vector comprising an ordered series of the first outside arm icon, the left arm icon, the modification icon, the right arm icon, and the second outside arm icon.

24. The DNA server computer of claim 23, wherein the modification icon of the second vector and the modification icon of the third vector are visually aligned with the target region icon of the wild type representation.

25. The DNA server computer of claim 20, wherein the wild type sequence received from the user computing device is a wild type label representing the DNA sequences and wherein the DNA server computer is further programmed to determine the DNA sequences associated with the wild type label.

26. The DNA server computer of claim 20, wherein the targeting vector components received from the user computing device is a targeting vector label representing DNA sequences and wherein the DNA server computer is further programmed to determine the DNA sequences associated the targeting vector label.

27. The DNA server computer of claim 20, wherein the DNA server computer is further programmed to:
receive from the user computing device a cDNA input;
receive from the user computing device a user display preference for the modification sequence icon;
determine a plurality of exons with associated exon locations and associated exon sizes for each of the left arm, the right arm, and the target region using the cDNA;
represent on the graphical image display the left arm icon comprising the plurality of left arm exons at their associated exon locations and associated exon sizes;
represent on the graphical image display the right arm icon comprising the plurality of right arm exons at their associated exon locations and associated exon sizes;
represent on the graphical image display the target region icon comprising the plurality of target region exons at their associated exon locations and associated exon sizes; and
represent on the graphical image display the modification icon comprising the user display preference.

28. The DNA server computer of claim 20, wherein the DNA server computer is further programmed to:
receive from the user computing device sequence motif components;
determine sequence motif icons associated with the sequence motif components;
determine sequence motif locations associated with the sequence motif icons; and
represent on the graphical display image the sequence motif icons at the associated sequence motif locations.

29. The DNA server computer of claim 28, wherein the sequence motif is a repetitive sequence.

30. The DNA server computer of claim 28, wherein the sequence motif is restriction enzymes.

31. The DNA server computer of claim 28, wherein the sequence motif is oligos.

32. The DNA server computer of claim 28, wherein the sequence motif is probes.

33. The DNA server computer of claim 32, wherein the DNA server computer is further programmed to:
determine at least one southern enzyme candidate associated with each of the probes;
transmit to the user computing device the at least one southern enzyme candidate for each of the probes;
receive from the user computing device a selection from the at least one southern enzyme candidate for each of the probes;
determine a first and second southern enzyme icon associated with the selected southern enzyme candidate for each of the probes;
determine a first southern enzyme location associated with the first southern enzyme icon and a second southern enzyme location associated with the second southern enzyme icon for each of the probes; and
represent on the graphical display image the first southern enzyme icon at the first southern enzyme location and the second southern enzyme icon at the second southern enzyme location for each of the probes.

34. The DNA server computer of claim 20, wherein the DNA server computer is further programmed to generate a DNA sequence report.

35. The DNA server computer of claim 20, wherein the DNA server computer is further programmed to represent on the graphical display image text descriptions of icons in near proximity thereto.

36. The DNA server computer of claim 20, wherein the DNA server computer is further programmed to provide to the user computing device instructions to enable the user computing device to display an object when an associated icon is selected.

37. The DNA server computer of claim 36, wherein the icon is selected by hovering over the icon.

38. The DNA server computer of claim 36, wherein the icon is selected by clicking the icon.

39. A DNA computer for imaging DNA sequences in gene-targeting processes, the DNA computer programmed to:
input a wild type sequence comprising DNA sequences, and targeting vector components comprising DNA sequences for a left arm, a modification, and a right arm
determine a target region using the wild type sequence and the targeting vector components;
determine a left arm icon algorithmically proportionate with a length of the left arm DNA sequence, a target region icon algorithmically proportionate with a length of the target region DNA sequence, a right arm icon algorithmically proportionate with a length of the right arm DNA sequence, and a modification icon algorithmically proportionate with a length of the modification DNA sequence;
generate a wild type representation comprising an ordered series of at least the left arm icon, the target region icon, and the right arm icon;
generate a second vector comprising an ordered series of at least the left arm icon, the modification icon, and the right arm icon;
generate a graphical display image comprising the wild type representation and the second vector; and
display the graphical display image.

40. The DNA computer of claim 39, wherein the DNA server computer is further programmed to:
determine a first outside arm and a second outside arm using the wild type sequence and the targeting vector components; and
determine a first outside arm icon algorithmically proportionate with a length of the first outside arm DNA sequence and a second outside arm icon algorithmically proportionate with a length of the second outside arm DNA sequence.

41. The DNA computer of claim 40, wherein the wild type representation and the second vector further comprises the first outside arm icon before in the ordered series the left arm icon and the second outside arm icon after in the ordered series the right arm icon.

42. The DNA computer of claim 40, wherein the graphical display image further comprises a third vector comprising an ordered series of the first outside arm icon, the left arm icon, the modification icon, the right arm icon, and the second outside arm icon.

43. The DNA computer of claim 42, wherein the modification icon of the second vector and the modification icon of the third vector are visually aligned with the target region icon of the wild type representation.

44. The DNA computer of claim 39, wherein the input wild type sequence is a wild type label representing the DNA sequences and wherein the DNA computer is further programmed to determine the DNA sequences associated with the wild type label.

45. The DNA computer of claim 39, wherein the input targeting vector components is a targeting vector label representing the DNA sequences and wherein the DNA computer is further programmed to determine the DNA sequences associated the targeting vector label.

46. The DNA computer of claim 39, wherein the DNA computer is further programmed to:
input a cDNA input;
input a user display preference for the modification sequence icon;
determine a plurality of exons with associated exon locations and associated exon sizes for each of the left arm, the right arm, and the target region using the cDNA;
represent on the graphical image display the left arm icon comprising the plurality of left arm exons at their associated exon locations and associated exon sizes;
represent on the graphical image display the right arm icon comprising the plurality of right arm exons at their associated exon locations and associated exon sizes;
represent on the graphical image display the target region icon comprising the plurality of target region exons at their associated exon locations and associated exon sizes; and
represent on the graphical image display the modification icon comprising the user display preference.

47. The DNA computer of claim 39, wherein the DNA computer is further programmed to:
input sequence motif components;
determine a sequence motif icons associated with the sequence motif components;
determine sequence motif locations associated with the sequence motif icons; and
represent on the graphical display image the sequence motif icons at the associated sequence motif locations.

48. The DNA computer of claim 47, wherein the sequence motif is a repetitive sequence.

49. The DNA computer of claim 47, wherein the sequence motif is restriction enzymes.

50. The DNA computer of claim 47, wherein the sequence motif is oligos.

51. The DNA computer of claim 47, wherein the sequence motif is probes.

52. The DNA computer of claim 51, wherein the DNA computer is further programmed to:
determine at least one southern enzyme candidate associated with each of the probes;
display the at least one southern enzyme candidate for each of the probes;
input a selection from the at least one southern enzyme candidate for each of the probes;
determine a first and second southern enzyme icon associated with the selected southern enzyme candidate for each of the probes;
determine a first southern enzyme location associated with the first southern enzyme icon and a second southern enzyme location associated with the second southern enzyme icon for each of the probes; and
represent on the graphical display image the first southern enzyme icon at the first southern enzyme location and the second southern enzyme icon at the second southern enzyme location for each of the probes.

53. The DNA computer of claim 39, wherein the DNA computer is further programmed to generate a DNA sequence report.

54. The DNA computer of claim 39, wherein the DNA computer is further programmed to represent on the graphical display image text descriptions of icons in near proximity thereto.

55. The DNA computer of claim 39, wherein the DNA computer is further programmed to display an object when an associated icon is selected.

56. The DNA computer of claim 55, wherein the icon is selected by hovering over the icon.

57. The DNA computer of claim 55, wherein the icon is selected by clicking the icon.
